(19) United States
(12) Patent Application Publication
(10) Pub. No.: US 2025/0007591 A1
(43) Pub. Date: Jan. 2, 2025

(54) BEAM FINDING PROCEDURE PERFORMED BY A USER EQUIPMENT

(71) Applicant: Telefonaktiebolaget LM Ericsson (publ), Stockholm (SE)

(72) Inventors: Fredrik ATHLEY, VÄSTRA FRÖLUNDA (SE); Andreas NILSSON, Göteborg (SE); Sven PETERSSON, SÄVEDALEN (SE)

(73) Assignee: Telefonaktiebolaget LM Ericsson (publ), Stockholm (SE)

(21) Appl. No.: 18/703,134

(22) PCT Filed: Oct. 20, 2021
(86) PCT No.: PCT/EP2021/079140

§ 371 Date: Apr. 19, 2024

(51) Int. Cl. H04B 7/06; H04W 48/08

(52) U.S. Cl. CPC H04B 7/06952; H04W 48/08

(57) ABSTRACT

There is provided mechanisms for performing a beam finding procedure with a serving access network node. A method is performed by a user equipment. The method comprises receiving, as part of performing the beam finding procedure, at least two SSBs. Each of the at least two SSBs comprises a PSS and an SSS. In each of the SSBs, the PSS comprises a PSS sequence and the SSS comprises an SSS sequence. All the SSBs have same PSS sequence but mutually different SSS sequences. The method comprises including the symbol in which the PSS of the SSB was received from the serving access network node in a set of evaluation symbols when received power of at least one of the SSS of the SSB received from the serving access network node and the SSS of any SSB not received from the serving access network node fulfils a power relation criterion.

### TECHNICAL FIELD

Embodiments presented herein relate to a method, a user equipment, a computer program, and a computer program product for performing a beam finding procedure with a serving access network node.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different carrier frequencies could be needed. For example, low such frequency bands could be needed to achieve sufficient network coverage for wireless devices and higher frequency bands (e.g. at millimeter wavelengths (mmW), i.e. near and above 30 GHz) could be needed to reach required network capacity. In general terms, at high frequencies the propagation properties of the radio channel are more challenging and beamforming both at the network node of the network and at the wireless devices might be required to reach a sufficient link budget.

Narrow beam transmission and reception schemes might be needed at such high frequencies to compensate the expected high propagation loss. For a given communication link, a respective beam can be applied at both the network-end (as represented by a network node or its transmission and reception point, TRP) and at the terminal-end (as represented by a user equipment), which typically is referred to as a beam pair link (BPL). One task of the beam management procedure is to discover and maintain beam pair links. A BPL (i.e. both the beam used by the network node and the beam used by the user equipment) is expected to be discovered and monitored by the network using measurements on downlink reference signals, such as channel state information reference signals (CSI-RS) or synchronization signal block (SSB) signals, used for beam management.

The CSI-RS for beam management can be transmitted periodically, semi-persistently or aperiodically (event triggered) and they can be either shared between multiple user equipment or be device-specific. The SSBs are transmitted periodically and are shared for all user equipment. In order for the user equipment to find a suitable network node beam, the network node, during the P-1 sub-procedure, transmits the reference signal in different transmission (TX) beams on which the user equipment performs measurements, such as reference signal received power (RSRP), and reports back the N best TX beams (where N can be configured by the network). Furthermore, the transmission of the reference signal on a given TX beam can be repeated to allow the user equipment to evaluate a suitable reception (RX) beam. Reference signals that are shared between all user equipment served by the TRP might be used to determine a first, coarse, direction for the user equipment. It could be suitable for such a periodic TX beam sweep at the TRP to use SSB as the reference signal. One reason for this is that SSBs are anyway transmitted periodically (for initial access/synchronization purposes) and SSBs are also expected to be beamformed at higher frequencies to overcome the higher propagation losses noted above.

A finer beam sweep in more narrow beams than used during the P-1 sub-procedure might then be performed at the network node during a P-2 sub-procedure to determine a more detailed direction for each user equipment. Here, the CSI-RS might be used as reference signal. As for the P-1 sub-procedure, the user equipment performs measurements, such as reference signal received power (RSRP), and reports back the N best TX beams (where N can be configured by the network).

Furthermore, the CSI-RS transmission in the transmission beam selected during the P-2 sub-procedure can be repeated in a P-3 sub-procedure to allow the user equipment to evaluate suitable RX beams at the user equipment.

SSB is a broadcast signal with the main purpose of providing initial synchronization, basic system information used for initial access and mobility measurements. Two examples structures of SSBs 100a, 100b are shown in FIG. 1 at (a) and (b). The SSB is composed of a Primary Synchronization Signal (PSS) 110, 110-1, 110-2, a Secondary Synchronization Signal (SSS) 130, 130-1, 130-2, and a Physical Broadcast CHannel (PBCH) 120, 120-1, 120-2, 130, 140, 140-1, 140-2. In some examples, the PSS and SSS parts of the SSB are transmitted over 127 sub-carriers, where the sub-carrier spacing could be 15 kHz or 30 kHz for below 6 GHz and 120 kHz or 240 kHz for above 6 GHz.

In some types of wireless networks, three different PSS sequences can be used. These are derived from different cyclic shifts of a basic length-127 M-sequence. When the user equipment has detected a PSS it knows the transmission timing of the SSS. In some types of wireless networks there are 336 different SSS sequences which are derived from shifts of two basic M-sequences. The combination of PSS and SSS determines the physical cell identity (PCI) of the cell. The 336 different SSSs together with the 3 different PSSs give 1008 different PCIs.

For low frequencies it is expected that the access network node in each cell transmits one SSB that covers the whole cell while for higher frequencies several beamformed SSB is expected to be needed to attain coverage over the whole cell. In some types of wireless networks the maximum number of SSBs per cell is as follows. For below 3 GHz: 4 SSBs per cell, for 3-6 GHz: 8 SSBs per cell, and for above 6 GHz: 64 SSBs per cell. The SSBs can be transmitted in an SSB transmission burst which could last up to 5 ms. The periodicity of the SSB burst is configurable. In some examples the periodicity is either 5, 10, 20, 40, 80, or 160 ms.

One alternative way for the user equipment to select a reception beam during the P-3 sub-procedure is to, instead of measuring on CSI-RSs, let the user equipment evaluate different candidate reception beams during the periodic SSB transmissions. One benefit with using SSB instead of CSI-RS is that no extra overhead of CSI-RS transmission is needed. As will be explained next, in theory, if each SSB is composed of four OFDM symbols, as in FIG. 1(a), a maximum of four candidate reception beams can be evaluated during each SSB burst transmission. The user equipment could thereby use one candidate reception beam per OFDM symbol and measure the received power with respect to each candidate reception beam. In this way, a maximum of four candidate reception beams can in theory be evaluated in one SSB transmission. However, the first symbol in an SSB, i.e., the symbol carrying the PSS, may not be useful for evaluating a candidate reception beam since the reception of the PSS from the serving access network node can be contaminated with PSS transmissions from other access network nodes using the same PSS sequence. This is due to that are only three different PSS sequences available and therefore there is a high probability that an access network node in a nearby cell is using the same PSS sequence. If an access network node in a nearby cell uses the same PSS sequence, the evaluation of candidate reception beams becomes unreliable since the user equipment will receive the same signal from multiple access network nodes. Therefore, it is in practice often assumed that the user equipment cannot use the first OFDM symbol in the SSB for finding a suitable reception beam. Hence, according to the SSB in FIG. 1(a) only three out of four OFDM symbols can be used during the evaluation. The same holds also for the SSB in FIG. 1(b) where all symbols containing the PSS are unusable. This leads to a longer latency in P-3 sub-procedure compared to if all symbols of the SSB could be used.

Hence, there is a need for improved beam finding procedures, and especially for procedures for the user equipment to evaluate candidate reception beams.

### SUMMARY

An object of embodiments herein is to provide efficient beam finding that does not suffer from the above issues, or at least where the above issues are reduced or mitigated.

According to a first aspect there is presented a method for performing a beam finding procedure with a serving access network node. The method is performed by a user equipment. During the beam finding procedure the user equipment evaluates a set of candidate beams based on measurements on a set of evaluation symbols with at least one evaluation symbol per candidate beam. The method comprises receiving, as part of performing the beam finding procedure, at least two SSBs. Each SSB is composed of symbols and is received from a respective access network node, one of which being the serving access network node. Each of the at least two SSBs comprises a PSS and an SSS. In each of the SSBs, the PSS comprises a PSS sequence and the SSS comprises an SSS sequence. All the SSBs have same PSS sequence but mutually different SSS sequences. The method comprises including the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

According to a second aspect there is presented a user equipment for performing a beam finding procedure with a serving access network node. The user equipment is configured to during the beam finding procedure evaluates a set of candidate beams based on measurements on a set of evaluation symbols with at least one evaluation symbol per candidate beam. The user equipment comprises processing circuitry. The processing circuitry is configured to cause the user equipment to receive, as part of performing the beam finding procedure, at least two SSBs. Each SSB is composed of symbols and is received from a respective access network node, one of which being the serving access network node. Each of the at least two SSBs comprises a PSS and an SSS. In each of the SSBs, the PSS comprises a PSS sequence and the SSS comprises an SSS sequence. All the SSBs have same PSS sequence but mutually different SSS sequences. The processing circuitry is configured to cause the user equipment to include the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

According to a third aspect there is presented a user equipment for performing a beam finding procedure with a serving access network node. The user equipment is configured to during the beam finding procedure evaluates a set of candidate beams based on measurements on a set of evaluation symbols with at least one evaluation symbol per candidate beam. The user equipment comprises a receive module configured to receive, as part of performing the beam finding procedure, at least two SSBs. Each SSB is composed of symbols and is received from a respective access network node, one of which being the serving access network node. Each of the at least two SSBs comprises a PSS and an SSS. In each of the SSBs, the PSS comprises a PSS sequence and the SSS comprises an SSS sequence. All the SSBs have same PSS sequence but mutually different SSS sequences. The user equipment comprises an include module configured to include the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

According to a fourth aspect there is presented a computer program for performing a beam finding procedure with a serving access network node, the computer program comprising computer program code which, when run on a user equipment, causes the user equipment to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient beam finding without suffering from the above issues.

Advantageously, these aspects enable all symbols of the SSB to be used by the user equipment for beam finding purposes

Advantageously, these aspects can be used to reduce the latency of the P-3 sub-procedure, thus resulting in faster beam finding since the user equipment is enabled to evaluate more candidate reception beams per SSB transmission.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates SSBs according to examples;

FIG. 2 is a schematic diagram illustrating a communications network according to embodiments;

FIGS. 3 and 5 are flowcharts of methods according to embodiments;

FIG. 4 schematically illustrates evaluation of candidate reception beams at the user equipment based on measurements on SSBs according to an embodiment;

FIG. 6 is a schematic diagram showing functional units of a user equipment according to an embodiment;

FIG. 7 is a schematic diagram showing functional modules of a user equipment according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

FIG. 2 is a schematic diagram illustrating a communication network 200 where embodiments presented herein can be applied. The communication network 200 could be a third generation (3G) telecommunications network, a fourth generation (4G) telecommunications network, a fifth generation (5G) telecommunications network, a sixth generation (6G) telecommunications network or any evolvement thereof, and support any 3GPP telecommunications standard, where applicable. The communication network 200 could alternatively be a non-cellular and/or a non-3GPP network, such as an IEEE 802.11 communications network, or any other wireless IEEE compliant communications network. The communication network 200 comprises a (radio) access network represented by cells 210a, 210b, 210c in which network access is provided by a respective access network node 220a, 220b, 220c. Each cell 210a, 210b, 210c share the same PSS sequence, denoted “PSS 1” in the figure. Further, each cell has its own SSS sequence, denoted “SSS 1”, “SSS 2”, and “SSS 3” in the figure. A user equipment 600 is assumed to be served by access network node 220a. Access network node 220a is thus the serving access network node for user equipment 600. Examples of access network nodes 220a, 220b, 220c are radio access network nodes, radio base stations, base transceiver stations, Node Bs, evolved Node Bs, gNBs, access points, and integrated access and backhaul nodes. Examples of user equipment 600 are wireless devices, mobile stations, mobile phones, handsets, wireless local loop phones, smartphones, laptop computers, tablet computers, network equipped sensors, network equipped vehicles, and so-called Internet of Things devices. The access network nodes 220a, 220b, 220c are operatively connected to a core network which in turn is operatively connected to one or more service networks. Other components, as well as the related functionality, of the communication network 200 are omitted in order not to obscure the concepts presented herein.

As noted above, there is a need for improved beam finding procedures, and especially for procedures for the user equipment to evaluate candidate reception beams.

In this respect, one benefit with using SSB transmissions for the user equipment to evaluate candidate reception beams is that the SSB is transmitted continuously for other purposes so that there is no additional overhead with using it also for evaluating candidate reception beams. Furthermore, the user equipment measures continuously on SSBs from access network nodes in multiple cells for mobility purposes.

However, as disclosed above, in densely deployed wireless networks it might be difficult to use all OFDM symbols in the SSB for evaluating candidate reception beams at the user equipment since it is likely that the user equipment will receive a PSS with high received power from access network nodes in multiple cells using the same PSS sequence. In some network deployments, however, the cell isolation is so high that, for some of the user equipment, the PSS from access network nodes other than the serving access network node is received with very low power.

For user equipment positioned such as signals received from access network nodes other than the serving access network node are weak, reliable measurements of the received power of the PSS transmitted from the serving access network node is possible. For example, if each access network node has three sectors, the access network nodes can use one PSS sequence per sector, i.e., three different PSS sequences in total. The user equipment can then measure on the PSS without any significant interference since there is no PSS transmitted with the same PSS sequence from the same access network node and the PSSs received from access network nodes in other cells are weak. However, on the cell edge there might be strong interference from PSS transmitted from neighboring network nodes. This is just one example. In this case, the user equipment can in practice use all symbols of the SSB for evaluating candidate reception beams.

The embodiments disclosed herein therefore relate to mechanisms for performing a beam finding procedure with a serving access network node 220a. In order to obtain such mechanisms there is provided a user equipment 600, a method performed by the user equipment 600, a computer program product comprising code, for example in the form of a computer program, that when run on a user equipment 600, causes the user equipment 600 to perform the method.

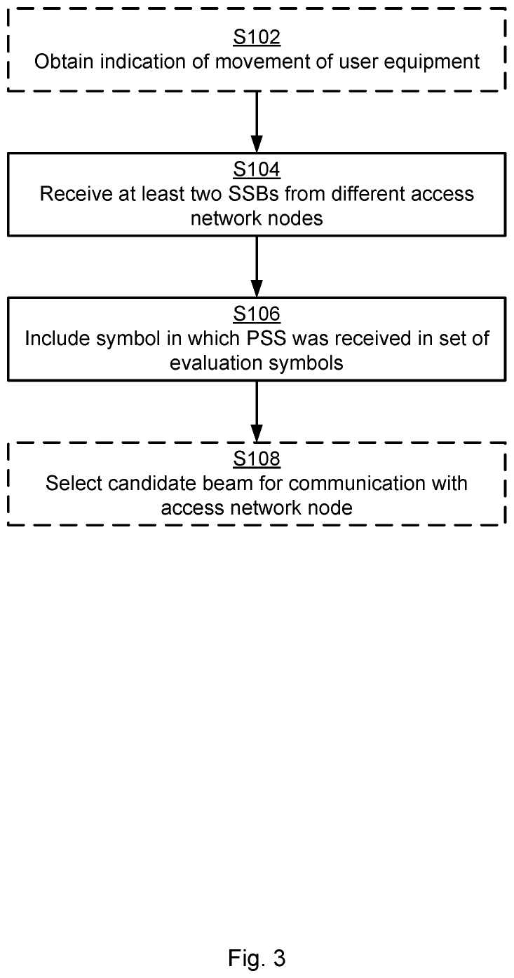

FIG. 3 is a flowchart illustrating embodiments of methods for performing a beam finding procedure with a serving access network node 220a. The methods are performed by the user equipment 600. During the beam finding procedure the user equipment 600 evaluates a set of candidate beams based on measurements on a set of evaluation symbols with at least one evaluation symbol per candidate beam. The methods are advantageously provided as computer programs 820.

In short, based on measurements on SSBs received from both the serving access network node and access network nodes in neighboring cells, the user equipment determines if the symbol holding the PSS can be used for evaluating candidate reception beams.

The user equipment 600 receives SSBs from (at least) two different access network nodes 220a, 220b, 220c, as in S104:

S104: The user equipment 600 receives, as part of performing the beam finding procedure, at least two SSBs 100a, 100b. Each SSB 100a, 100b is composed of symbols and is received from a respective access network node 220a, 220b, 220c. One of the access network nodes 220a, 220b, 220c is the serving access network node 220a.

The PSS sequences are the same in the received SSBs. In further detail, each of the at least two SSBs 100a, 100b comprises a PSS 110, 110-1, 110-2 and a SSS, 130, 130-1, 130-2. In each of the SSBs 100a, 100b, the PSS 110, 110-1, 110-2 comprises a PSS sequence and the SSS 130, 130-1, 130-2 comprises an SSS sequence. All the SSBs 100a, 100b have same PSS sequence but mutually different SSS sequences.

The user equipment 600 decides whether or not to include the PSS (of the SSB received from the serving access network node 220a) in the set of evaluation symbols used when evaluating the candidate beams, as in S106:

S106: The user equipment 600 includes the symbol in which the PSS 110, 110-1, 110-2 of the SSB 100a, 100b was received from the serving access network node 220a in the set of evaluation symbols when received power of at least one of the SSS 130, 130-1, 130-2 of the SSB 100a, 100b received from the serving access network node 220a and the SSS 130, 130-1, 130-2 of any SSB 100a, 100b not received from the serving access network node 220a fulfils a power relation criterion.

In some aspects, the actual evaluation of the set of candidate beams is made for the next-most coming transmission of the SSB 100a, 100b from the serving access network node 220a. That is, if it for transmission n of the SSB 100a, 100b from the serving access network node 220a is determined to include the symbol in which the PSS 110, 110-1, 110-2 of the SSB 100a, 100b was received from the serving access network node 220a in the set of evaluation symbols, the actual evaluation of the set of evaluation symbols is made for the SSS and PSSS in transmission n+1 of the SSB 100a, 100b from the serving access network node 220a.

Accordingly, the user equipment measures the received power of the symbol holding the SSS in SSBs received from access network nodes in other cells that use the same PSS sequence as the serving cell in order to assess if the PSS symbol can be used for evaluating candidate reception beams. To this end, the user equipment considers the received power of the SSS 130, 130-1, 130-2 of the SSB 100a, 100b received from the serving access network node 220a (possibly together with the PSS of the SSB received from the serving access network node 220a) and/or the SSS 130, 130-1, 130-2 of any SSB 100a, 100b not received from the serving access network node 220a.

In some examples, the user equipment compares the received power of the SSS received in SSBs from access network nodes in other cells to the received power of the SSS received in SSBs from the serving access network node. If received power of the SSS received in SSBs from access network nodes in other cells power is significantly lower than the received power of the SSS received in SSBs from the serving access network node, it can be deduced that also the received power from the PSS received in SSBs from these access network nodes in other cells will be significantly lower than the received power of the PSS received in SSBs from the serving access network node. Hence, the interference with respect to the PSS is low and reliable measurements on the PSS for evaluating candidate reception beams are possible. The user equipment can then decide to include all symbols of the SSB transmissions when evaluating candidate reception beams, thereby reducing the beam finding latency accordingly.

Embodiments relating to further details of performing a beam finding procedure with a serving access network node 220a as performed by the user equipment 600 will now be disclosed.

The set of candidate beams might be evaluated for finding which candidate beam in the set of candidate beams the user equipment 600 is to use for communication with the serving access network node 220a.

In some aspects, the beam finding procedure is triggered when the UE is moving in order to speed up the procedure of evaluating candidate reception beams. Hence, in some embodiments, the user equipment 600 is configured to perform (optional) step S102:

S102: The user equipment 600 obtains an indication that the user equipment 600 is moving with a speed (and/or angular movement) higher than a speed threshold value. Performing the beam finding procedure is then triggered in response thereto (i.e., in response to the user equipment 600 having obtained the indication).

Aspects of how the user equipment might estimate the level of interference, as caused by other access network nodes, for the symbol holding the PSS will be disclosed next.

In some aspects, the user equipment measures the received power of the SSS in SSBs received from other access nodes having the same PSS sequence as the serving access network node and compares this with the power of the SSS in SSB received from the serving access network node. If the received power of the SSSs in SSBs received from the other access nodes is low, the interference for the symbol holding the PSS the PSS is also considered low. The user equipment might therefore determine that the power relation criterion is fulfilled, and thus that the symbol holding the PSS can be used for evaluating candidate reception beams, when:

$$\frac{{Σ}_{k \neq 0} {P}_{SSS , k}}{{P}_{SSS , 0}} < θ or \frac{{max}_{k \neq 0} {P}_{SSS , k}}{{P}_{SSS , 0}} < θ$$

where P_{SSS,0} is the received power of the SSS 130, 130-1, 130-2 received from the serving access network node 220a, P_{SSS,k} is the received power of the SSS received from access network node 220b, 220c k not serving the user equipment 600, where access network node 220b, 220c k has the same PSS sequence as the serving access network node 220a, and where θ is a threshold power value. The threshold power value is a design parameter determined by, or signalled to, the user equipment.

In some aspects, the user equipment only considers the received power of the SSS in SSBs received from other access nodes having the same PSS sequence as the serving access network node. Particularly, the user equipment might determine that the power relation criterion is fulfilled, and thus that the symbol holding the PSS can be used for evaluating candidate reception beams, when:

$${\sum }_{k \neq 0} {P}_{SSS , k} < θ or {max}_{k \neq 0} {P}_{S S S , k} < θ$$

In some aspects, the user equipment considers the received power of the SSS in SSBs received from the serving access network node and compares this with the received power of the PSS. One motivation for this is that if there is no interference from other access nodes having the same PSS sequence, the received power of the PSS and the SSS should be the same if they are transmitted with the same power. Particularly, the user equipment might determine that the power relation criterion is fulfilled, and thus that the symbol holding the PSS can be used for evaluating candidate reception beams, when:

$$\frac{{P}_{PSS , 0}}{{P}_{SSS , 0}} < θ$$

where P_{PSS,0} is the received power of the PSS 110, 110-1, 110-2, and P_{SSS,0} is the received power of the SSS 130, 130-1, 130-2, received from the serving access network node 220a, and where θ is a threshold power value.

In general terms, when comparing two measurements that have been made with beams having different beamwidths, the power might be adjusted to take the difference in beamforming gain into account. Hence, in some embodiments, the SSBs 100a, 100b are received in beams with mutually different beamforming gains, and a compensation is made for the beamforming gains when determining whether the power relation criterion is fulfilled or not. According to one example, the user equipment uses a wide beam for receiving the SSS in the SSBs from access network nodes in other cells (having the same PSS sequence as the serving cell) and a narrow beam for receiving the SSS in the SSB from the serving access network node. This could represent a scenario when the user equipment performs measurements on SSBs for mobility purposes. In some examples, the user equipment compensates the measured received power of the SSS in the SSBs from access network nodes in other cells according to the difference in beamforming gain between the narrow and wide beam.

According to another example, the user equipment uses narrow beams for receiving both the SSS in the SSBs from access network nodes in other cells and the SSB from the serving access network node. In this case, the user equipment does not need to compensate the measured received power of the SSS in the SSBs from access network nodes in other cells. In some examples, the user equipment uses the same narrow beam for receiving both the SSS in the SSBs from access network nodes in other cells and the SSB from the serving access network node as will potentially be used for receiving the PSS. Further, if the user equipment measures on the SSS in the SSB received from the serving access network node, the user equipment might use the same beam as used for receiving the PSS. In this case, there is no need to compensate the measured received power of the SSS. Hence, in some embodiments, all SSBs 100a, 100b are received in beams with equal beamforming gains.

Aspects of the beam finding procedure will be disclosed next.

In some embodiments, during the beam finding procedure, the user equipment 600 performs a beam sweep in the set of candidate beams, and each of the candidate beams is used for receiving, and measuring on, a respective one of the evaluation symbols.

In some aspects, the candidate beam in which the SSB 100a, 100b was received with highest received power is selected. In particular, in some embodiments, the user equipment 600 is configured to perform (optional) step S108:

S108: The user equipment 600 selects, for communication with the serving access network node 220a, the candidate beam in which the evaluation symbol is received with highest received power.

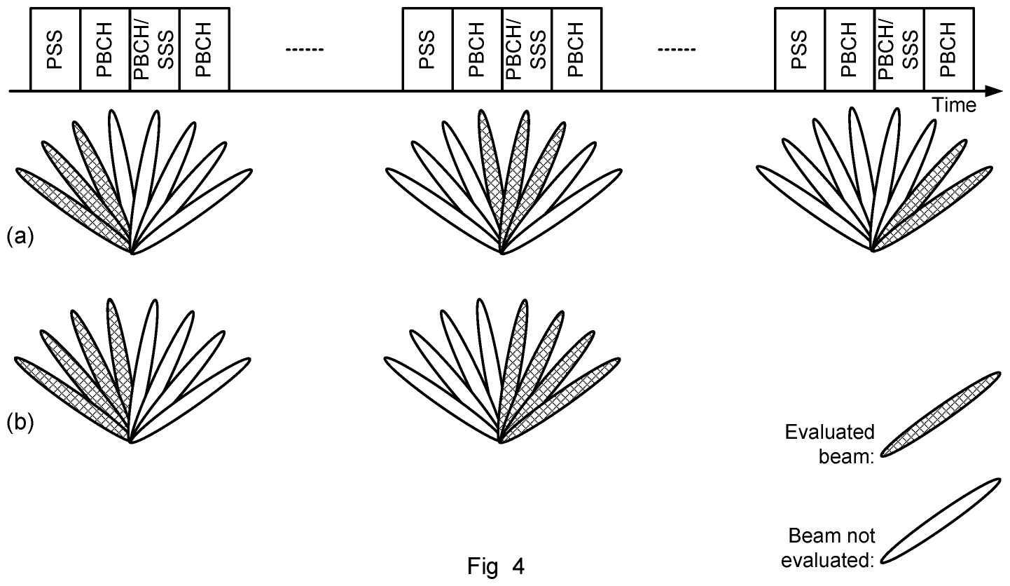

A schematic illustration of the herein disclosed inventive concept together with a comparison to prior art is provided in FIG. 4. In more detail, FIG. 4 shows evaluation of candidate reception beams at the user equipment based on measurements on SSBs.

For illustrative purposes it is assumed that the user equipment is configured to generate eight beams and that an SSB is transmitted every 20 ms. Beam sweeping as performed at the access network node is not shown and the figure shows the SSBs transmitted in a given beam from the access network node.

According to prior art, as shown at (a), the user equipment is capable of evaluating three beams per SSB transmission. Thus, it takes three SSB transmissions, or 40 ms (plus the duration of a single SSB transmission), for the user equipment to perform a complete beam sweep. With the herein disclosed embodiments, as shown at (b), the beam evaluation can be completed in two SSB transmissions, or 20 ms (plus the duration of a single SSB transmission), since the user equipment is capable of evaluating four beams per each SSB transmission.

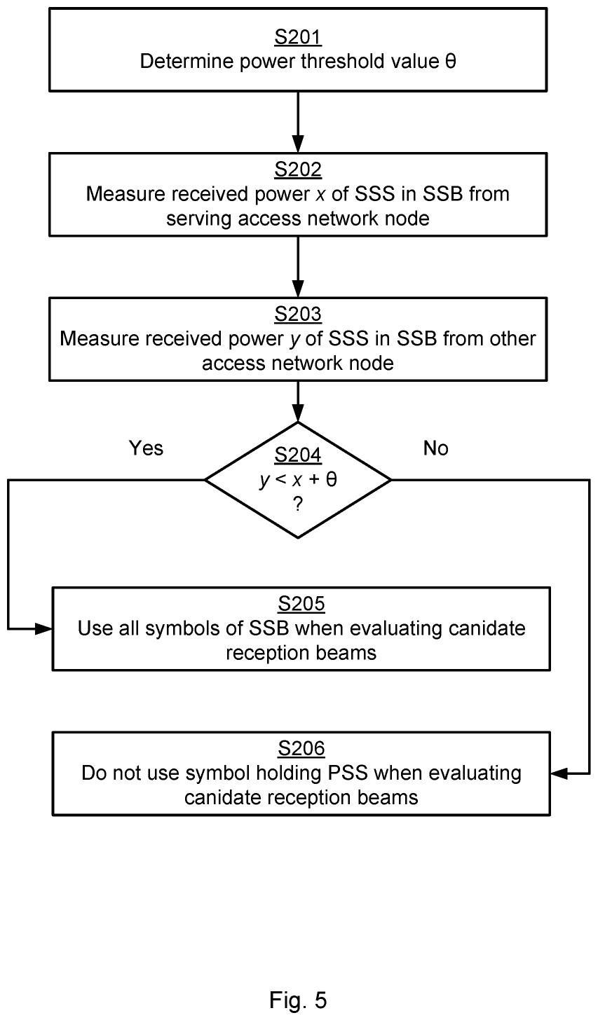

Reference is next made to FIG. 5. FIG. 5 is a flowchart illustrating one particular embodiment for performing a beam finding procedure with a serving access network node 220a as performed by the user equipment 600 based on at least some of the above disclosed embodiments, aspects, and examples.

S201: The user equipment 600 sets a power threshold value 0.

S202: The user equipment 600 measures the received power of the SSS in an SSB received from the serving access network node. The received power is assumed to be x dB.

S203: The user equipment 600 measures the received power of the SSS in SSBs received from other access network nodes in cells having the same PSS sequence as the cell of the serving access network node. The maximum received power is assumed to be y dB.

S204: The user equipment 600 compares the received power from S202 and S203. If y<x+θ, then step S205 is entered. Else, step S206 is entered.

S205: The user equipment 600 use all symbols of the SSB when evaluating candidate reception beams.

S206: The user equipment 600 does not use the symbol in the SSB holding the PSS when evaluating candidate reception beams.

The comparison of received power could be made either in linear scale or in logarithmic (dB) scale.

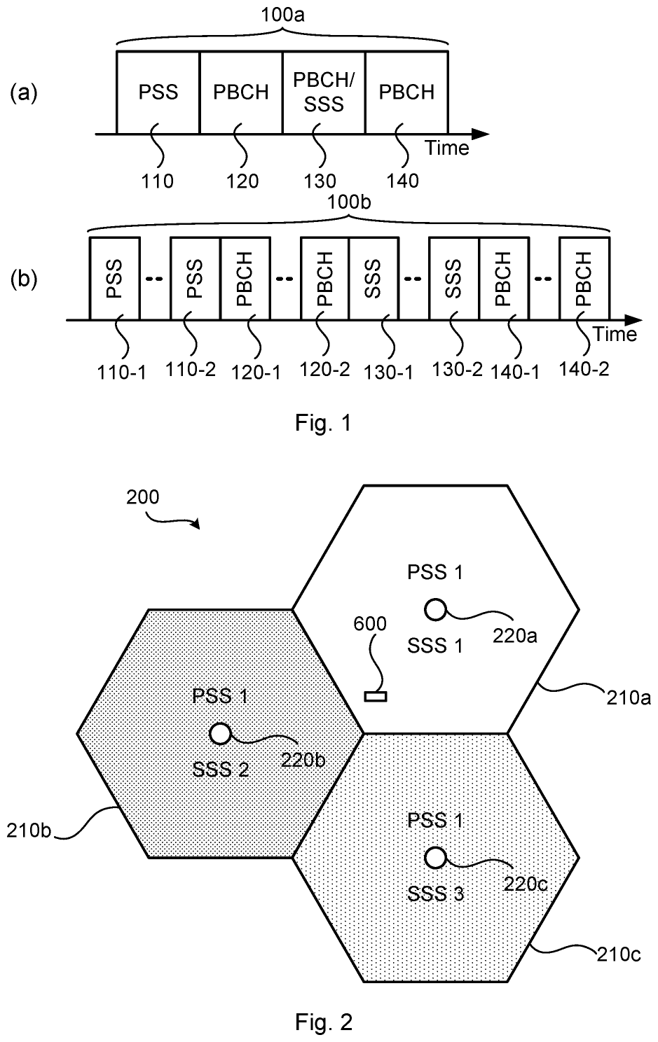

There could be different structures of the SSBs. In this respect, the herein disclosed embodiments are not limited to any particular structure of the SSBs as long as the above disclosed properties are fulfilled. In some examples, each of the SSBs 100a, 100b is composed of: one or more symbols containing the PSS 110, 110-1, 110-2, one or more symbols containing a PBCH signal 120, 140, and one or more symbols containing the SSS 130, 130-1, 130-2 and the PBCH signal. One non-limiting example of such an SSB is provided in FIG. 1(a). In other examples, the SSB is without any symbols containing both the SSS and the PBCH signal. One non-limiting example of such an SSB is provided in FIG. 1(b).

The user equipment might be equipped with multiple antenna panels. The different embodiments disclosed herein can be applied per antenna panel. It could be that candidate reception beams are evaluated only for the antenna panel currently used for data transmission/reception or for one or several other antenna panels. Hence, in some embodiments, the user equipment 600 comprises at least two antenna panels, each comprising at least two antenna elements, and the beam finding procedure is performed independently for each of the at least two antenna panels.

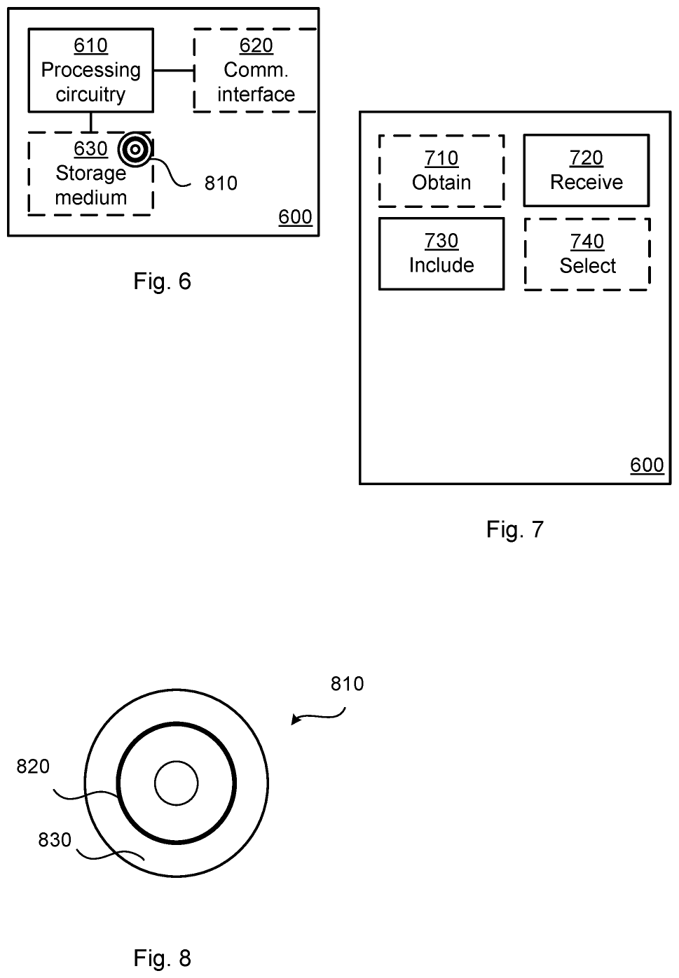

FIG. 6 schematically illustrates, in terms of a number of functional units, the components of a user equipment 600 according to an embodiment. Processing circuitry 610 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 630. The processing circuitry 610 may further be provided as at least one application specific integrated circuit (ASIC), or field programmable gate array (FPGA).

Particularly, the processing circuitry 610 is configured to cause the user equipment 600 to perform a set of operations, or steps, as disclosed above. For example, the storage medium 630 may store the set of operations, and the processing circuitry 610 may be configured to retrieve the set of operations from the storage medium 630 to cause the user equipment 600 to perform the set of operations. The set of operations may be provided as a set of executable instructions.

Thus the processing circuitry 610 is thereby arranged to execute methods as herein disclosed. The storage medium 630 may also comprise persistent storage, which, for example, can be any single one or combination of magnetic memory, optical memory, solid state memory or even remotely mounted memory. The user equipment 600 may further comprise a communications interface 620 at least configured for communications with other entities, functions, nodes, and devices, such as the access network nodes 220a, 220b, 220c. As such the communications interface 620 may comprise one or more transmitters and receivers, comprising analogue and digital components. The processing circuitry 610 controls the general operation of the user equipment 600 e.g. by sending data and control signals to the communications interface 620 and the storage medium 630, by receiving data and reports from the communications interface 620, and by retrieving data and instructions from the storage medium 630.

Other components, as well as the related functionality, of the user equipment 600 are omitted in order not to obscure the concepts presented herein.

FIG. 7 schematically illustrates, in terms of a number of functional modules, the components of a user equipment 600 according to an embodiment. The user equipment 600 of FIG. 7 comprises a number of functional modules; a receive module 720 configured to perform step S104, and an include module 730 configured to perform step S106. The user equipment 600 of FIG. 7 may further comprise a number of optional functional modules, such as any of an obtain module 710 configured to perform step S102, and a select module 740 configured to perform step S108. In general terms, each functional module 710:740 may in one embodiment be implemented only in hardware and in another embodiment with the help of software, i.e., the latter embodiment having computer program instructions stored on the storage medium 630 which when run on the processing circuitry makes the user equipment 600 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 710:740 may be implemented by the processing circuitry 610, possibly in cooperation with the communications interface 620 and/or the storage medium 630. The processing circuitry 610 may thus be configured to from the storage medium 630 fetch instructions as provided by a functional module 710:740 and to execute these instructions, thereby performing any steps as disclosed herein.

FIG. 8 shows one example of a computer program product 810 comprising computer readable storage medium 830. On this computer readable storage medium 830, a computer program 820 can be stored, which computer program 820 can cause the processing circuitry 610 and thereto operatively coupled entities and devices, such as the communications interface 620 and the storage medium 630, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing a beam finding procedure with a serving access network node, the method being performed by a user equipment, wherein during the beam finding procedure the user equipment evaluates a set of candidate beams based on measurements on a set of evaluation symbols with at least one evaluation symbol per candidate beam, the method comprising:
receiving, as part of performing the beam finding procedure, at least two synchronization signal blocks, SSBs, where each SSB is composed of symbols and is received from a respective access network node, one being the serving access network node,
wherein each of the at least two SSBs comprises a primary synchronization signal, PSS, and a secondary synchronization signal, SSS, wherein, in each of the SSBs, the PSS comprises a PSS sequence and the SSS comprises an SSS sequence, and wherein all the SSBs have same PSS sequence but mutually different SSS sequences; and
including the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

2. The method of claim 1, wherein the power relation criterion is fulfilled when:
$$\frac{{Σ}_{k \neq 0} {P}_{S S S , k}}{{P}_{SSS , 0}} < θ or \frac{{max}_{k \neq 0} {P}_{SSS , k}}{{P}_{SSS , 0}} < θ$$
where P_{SSS,0} is the received power of the SSS received from the serving access network node, P_{SSS,k} is the received power of the SSS received from access network node k not serving the user equipment, where access network node k has the same PSS sequence as the serving access network node, and where θ is a threshold power value.

3. The method of claim 1, wherein the power relation criterion is fulfilled when:
$${\sum }_{k \neq 0} {P}_{S S S , k} < θ or {max}_{k \neq 0} {P}_{S S S , k} < θ$$
where P_{SSS,0} is the received power of the SSS received from the serving access network node, P_{SSS,k} for k≠0 is the received power of the SSS received from access network node k not serving the user equipment, where access network node k has the same PSS sequence as the serving access network node, and where θ is a threshold power value.

4. The method of claim 1, wherein the power relation criterion is fulfilled when:
$$\frac{{P}_{PSS , 0}}{{P}_{SSS , 0}} < θ$$
where P_{PSS,0} is the received power of the PSS, and P_{SSS,0} is the received power of the SSS, received from the serving access network node, and where θ is a threshold power value.

5. The method of claim 1, wherein the SSBs are received in beams with mutually different beamforming gains, and wherein a compensation is made for the beamforming gains when determining whether the power relation criterion is fulfilled or not.

6. The method of claim 1, wherein all SSBs are received in beams with equal beamforming gains.

7. The method of claim 1, wherein the set of candidate beams is evaluated for finding which candidate beam in the set of candidate beams the user equipment is to use for communication with the serving access network node.

8. The method of claim 1, wherein, during the beam finding procedure, the user equipment performs a beam sweep in the set of candidate beams, and wherein each of the candidate beams is used for receiving, and measuring on, a respective one of the evaluation symbols.

9. The method of claim 8, wherein performing the beam finding procedure further comprises:
selecting, for communication with the serving access network node, the candidate beam in which the evaluation symbol is received with highest received power.

10. The method according to of claim 1, wherein the method further comprising:
obtaining an indication that the user equipment is moving with a speed higher than a speed threshold value, and wherein performing the beam finding procedure is triggered in response thereto.

11. The method according to of claim 1, wherein each of the SSBs is composed of: one or more symbols containing the PSS, one or more symbols containing a physical broadcast channel, PBCH, signal, and one or more symbols containing the SSS and the PBCH signal.

12. The method according to of claim 1, wherein the user equipment comprises at least two antenna panels, each comprising at least two antenna elements, and wherein the beam finding procedure is performed independently for each of the at least two antenna panels.

13. A user equipment for performing a beam finding procedure with a serving access network node, wherein the user equipment is configured to during the beam finding procedure evaluates a set of candidate beams based on measurements on a set of evaluation symbols with at least one evaluation symbol per candidate beam, the user equipment comprising processing circuitry, the processing circuitry being configured to cause the user equipment to:
receive, as part of performing the beam finding procedure, at least two synchronization signal blocks, SSBs, where each SSB is composed of symbols and is received from a respective access network node, one being the serving access network node,
wherein each of the at least two SSBs comprises a primary synchronization signal, PSS, and a secondary synchronization signal, SSS, wherein, in each of the SSBs, the PSS comprises a PSS sequence and the SSS comprises an SSS sequence, and wherein all the SSBs have same PSS sequence but mutually different SSS sequences; and
include the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

14-15. (canceled)

16. A computer program for performing a beam finding procedure with a serving access network node, wherein during the beam finding procedure the user equipment evaluates a set of candidate beams based on measurements on a set of evaluation symbols with at least one evaluation symbol per candidate beam, the computer program comprising computer code which, when run on processing circuitry of a user equipment, causes the user equipment to:
receive, as part of performing the beam finding procedure, at least two synchronization signal blocks, SSBs, where each SSB is composed of symbols and is received from a respective access network node, one being the serving access network node,
wherein each of the at least two SSBs comprises a primary synchronization signal, PSS, and a secondary synchronization signal, SSS, wherein, in each of the SSBs, the PSS comprises a PSS sequence and the SSS comprises an SSS sequence, and wherein all the SSBs have same PSS sequence but mutually different SSS sequences; and
include the symbol in which the PSS of the SSB was received from the serving access network node in the set of evaluation symbols when received power of at least one of the SSS of the SSB received from the serving access network node and the SSS of any SSB not received from the serving access network node fulfils a power relation criterion.

17. (canceled)
